(19) United States
(12) Patent Application Publication
(10) Pub. No.: US 2012/0160768 A1
(43) Pub. Date: Jun. 28, 2012

(54) ORGANIC-WASTEWATER TREATMENT METHOD AND ORGANIC-WASTEWATER TREATMENT APPARATUS

(75) Inventors: Yu Tanaka, Tokyo (JP); Tetsuro Fukase, Tokyo (JP); Shigeki Sawada, Tokyo (JP)

(73) Assignee: KURITA WATER INDUSTRIES LTD., Tokyo (JP)

(21) Appl. No.: 13/393,715

(22) PCT Filed: Sep. 29, 2009
(86) PCT No.: PCT/JP2009/066904

§ 371 Date: Mar. 1, 2012

(51) Int. Cl. C02F 3/12; C02F 1/44

(52) U.S. Cl. 210/620; 210/205

(57) ABSTRACT

By adding an iron salt, the sedimentation property, the concentration property, and the filtration property of sludge in an activated-sludge mixed liquor in a biological treatment tank are effectively improved and treated water of high quality is efficiently provided. When an iron salt such as ferrous chloride, ferric chloride, or polyferric sulfate is added to organic wastewater and the organic wastewater is biologically treated, the iron salt is added to the organic wastewater and mixing is conducted; and the water mixture is mixed with activated sludge and biologically treated. By mixing organic wastewater and an iron salt at a pH close to an optimum pH for ferric hydroxide in advance, the turbidity of the treated water due to the formation of iron oxide or ferrous carbonate is suppressed.

### FIELD OF INVENTION

The present invention relates to an organic-wastewater treatment method and an organic-wastewater treatment apparatus for biologically treating organic wastewater by an activated-sludge process, in particular, to a method and an apparatus for biologically treating organic wastewater by an activated-sludge process in which the sedimentation property, the concentration property, and the filtration property of sludge are improved to thereby efficiently provide treated water of high quality.

### BACKGROUND OF INVENTION

A biological treatment is known as a process for treating organic wastewater. Among the biological treatment processes, an activated-sludge process, which employs a microbial flora referred to as activated sludge, can be applied to organic-matter-containing waters having various properties and can provide treated water of high quality. Accordingly, the activated-sludge process is widely used.

A biological treatment tank in which the treatment is performed by the activated-sludge process holds therein a liquor (activated-sludge mixed liquor) obtained by mixing organic wastewater introduced into the treatment tank and activated sludge (microorganisms) held in the tank. Accordingly, to obtain clear treated water having been treated with the biological treatment tank, the activated-sludge mixed liquor needs to be subjected to solid-liquid separation.

The activated-sludge mixed liquor can be subjected to solid-liquid separation with a sedimentation basin, a membrane-separation apparatus, a floatation apparatus, or the like. Of these, the membrane-separation apparatus has a higher capability of separating solid content than the other solid-liquid separation apparatuses. Use of the membrane-separation apparatus can provide clear treated water.

When biologically treated water is subjected to solid-liquid separation, the following efforts have been made for improving the quality of the resultant treated water and the treatment efficiency.
i) When biologically treated water is subjected to solid-liquid separation with a sedimentation basin, a filter is further provided to improve the transparency of the treated water; or the MLSS concentration of the biological treatment tank is optimized; or the size of the sedimentation basin is increased.
ii) To improve the sedimentation property and the concentration property of sludge, a two-stage activated-sludge process is employed; or, for example, a flocculant having a high specific gravity (an iron salt, calcium, or the like) is added; or a polymeric flocculant is added.
iii) In the membrane-separation activated-sludge process in which the activated-sludge mixed liquor from the biological treatment tank is subjected to membrane separation, to suppress clogging of the membrane and to increase the flux (permeation flux), for example, chemical cleaning of the membrane, intermittent extraction of treated water, back washing of the membrane, optimization of the MLSS concentration of the biological treatment tank, and optimization of the sludge retention time (SRT) of the biological treatment tank are performed.

For example, Patent Document 1 proposes a method in which a flocculant is added to a submerged-membrane biological treatment tank to flocculate phosphorus so that release of phosphorus to biologically treated water is suppressed and adhesion of slime in a reverse-osmosis-membrane separation apparatus disposed downstream is suppressed.

The applicant of the subject application proposed, in the membrane-separation activated-sludge process of biologically treating organic wastewater with a biological treatment tank and subjecting the activated-sludge mixed liquor to membrane separation, a method in which an iron salt is added to the biological treatment tank and the pH in the biological treatment tank is adjusted to be 5 to 6.5 to suppress clogging of the separation membrane (Patent Document 2).

Patent Document 1: Japanese Patent Publication 2008-86849

Patent Document 2: Japanese Patent Publication 2008-200639

As described in Patent Document 2, by adding an iron salt to the biological treatment tank and by adjusting the pH in the biological treatment tank to be 5 to 6.5, very strong and large flocs can be formed; the sedimentation property, the concentration property, and the filtration property of sludge are improved; and the transparency of the treated water becomes high. In particular, when this method is applied to the membrane-separation activated-sludge process, a great advantage of maintaining the membrane flux to be high is provided.

However, when an iron salt is directly added to the biological treatment tank, a phenomenon where the treated water becomes brown and turbid is sometimes observed. The inventors of the present invention studied the phenomenon. As a result, they have found that the phenomenon is caused because the iron salt added to the biological treatment tank turns into iron oxide or ferrous carbonate in the biological treatment tank and leaks in the form of fine particles into the treated water, without being used for the formation of flocs.

### SUMMARY OF INVENTION

An object of the present invention is to overcome this problem and to provide a method and an apparatus for treating organic wastewater in which, by adding an iron salt, the sedimentation property, the concentration property, and the filtration property of sludge in an activated-sludge mixed liquor in a biological treatment tank are improved to thereby efficiently provide treated water of high quality.

The inventors of the present invention performed thorough studies on how to achieve the object. As a result, they have found that, by mixing organic wastewater and an iron salt at a pH close to an optimum pH for ferric hydroxide in advance prior to the biological treatment, the turbidity of the treated water due to the formation of iron oxide or ferrous carbonate is suppressed.

The present invention has been accomplished on the basis of such a finding.

A first embodiment is a method of adding an iron salt to organic wastewater and biologically treating the organic wastewater, the method including a mixing step of adding an iron salt to organic wastewater and conducting mixing, and a biological treatment step of mixing a water mixture from the mixing step with activated sludge and biologically treating the water mixture.

A second embodiment is that, in the first embodiment, the mixing step is performed at a pH of 4.5 to 6.5 and the biological treatment step is performed at a pH of 5 to 6.5.

A third embodiment is that, in the first or second embodiment, in the mixing step, the iron salt is added such that an iron content in the activated sludge in the biological treatment step is 10 to 45 wt %.

A fourth embodiment is that any one of the first to third embodiments further includes a membrane-separation step of subjecting an activated-sludge mixed liquor from the biological treatment step to membrane separation.

A fifth embodiment is an apparatus of adding an iron salt to organic wastewater and biologically treating the organic wastewater, the apparatus including a mixing tank configured to add an iron salt to organic wastewater and to conduct mixing, and a biological treatment tank configured to mix a water mixture from the mixing tank with activated sludge and to biologically treat the water mixture.

A sixth embodiment is that, in the fifth embodiment, a pH in the mixing tank is 4.5 to 6.5 and a pH in the biological treatment tank is 5 to 6.5.

A seventh embodiment is that, in the fifth or sixth embodiment, the iron salt is added to the mixing tank such that an iron content in the activated sludge in the biological treatment tank is 10 to 45 wt %.

An eighth embodiment is that any one of the fifth to seventh embodiments further includes membrane-separation means for subjecting an activated-sludge mixed liquor in the biological treatment tank to membrane separation.

According to the present invention, by mixing organic wastewater and an iron salt at a pH close to an optimum pH for ferric hydroxide in advance prior to the biological treatment, the added iron salt can be effectively used as ferric hydroxide. As a result, very strong and large flocs can be formed in the biological treatment tank; the sedimentation property, the concentration property, and the filtration property of sludge are effectively improved; and leakage of the iron content into the treated water is reduced.

In a sedimentation biological treatment in which the activated-sludge mixed liquor is subjected to solid-liquid separation with a sedimentation basin, the SS of the treated water is decreased to increase the transparency of the treated water.

In the membrane-separation activated-sludge process in which the activated-sludge mixed liquor is subjected to membrane separation, clogging of the membrane is suppressed to increase the membrane flux and to stably maintain the membrane flux for a long period of time.

### BRIEF DESCRIPTION OF DRAWINGS

FIG. 1 is a system diagram illustrating an organic-wastewater treatment apparatus according to an embodiment of the present invention.

FIG. 2 is a system diagram illustrating an organic-wastewater treatment apparatus according to another embodiment of the present invention.

### DETAILED DESCRIPTION

Hereinafter, an organic-wastewater treatment method and an organic-wastewater treatment apparatus according to embodiments of the present invention will be described in detail with reference to the drawings.

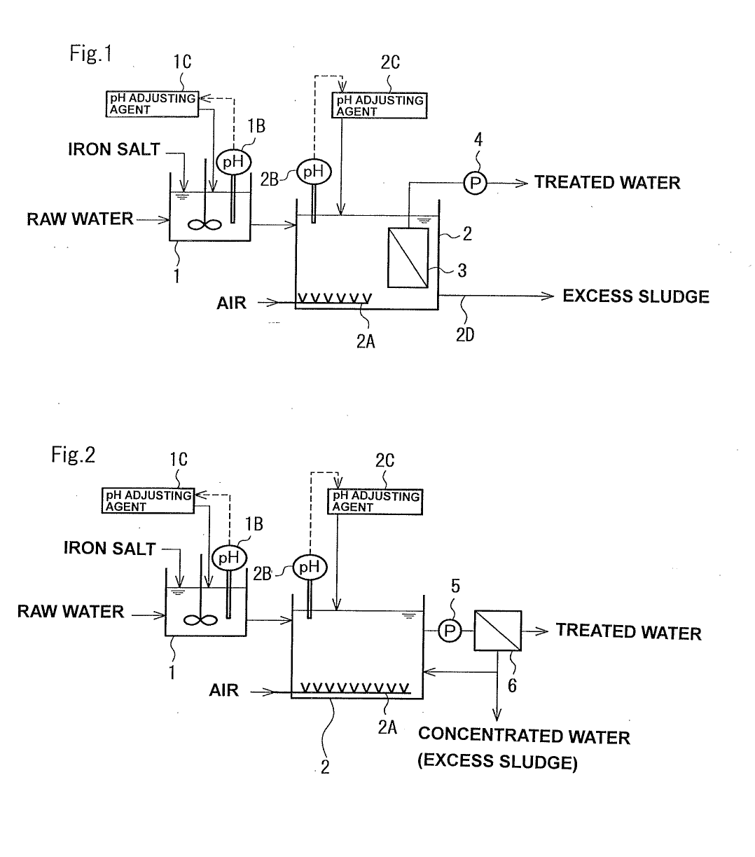

FIGS. 1 and 2 are system diagrams illustrating organic-wastewater treatment apparatuses according to embodiments of the present invention. In FIGS. 1 and 2, components having the same function are denoted by identical reference signs.

According to the present invention, when raw water composed of organic wastewater is introduced into a biological treatment tank 2 and biologically treated with activated sludge, an iron salt is added to and mixed with the raw water in an iron-salt-mixing tank 1 and the resultant water mixture is biologically treated in the biological treatment tank 2.

Examples of the organic wastewater to be treated by the present invention include natural waters such as ground water, river water, and lake (including dam lake) water, tap water, and recycled water obtained by treating wastewater. The present invention is suitably applicable to cases where such a water is treated as raw water and the resultant treated water is used to produce pure water.

These waters themselves have a low BOD concentration of about 0.1 to 100 mg/L. When the waters are used to produce pure water, the waters are biologically treated with, for example, mainly microorganisms that are called oligotrophic bacteria including pseudomonas, and subsequently subjected to solid-liquid separation with, for example, an ultrafiltration (UF) membrane or a membrane having a pore size of about 0.2 μM or less. Membranes used for treating water for producing pure water have a small pore size and hence tend to become clogged. In particular, natural water may contain humin that tend to cause clogging of membranes and may also have a high suspended solids (SS) concentration. The present invention provides a high capability of suppressing fouling and hence raw water may contain humin at a high concentration of more than 1 mg/L and may also contain SS in the range of about 0.1 to 30 mg/L.

When the MLSS concentration in the biological treatment tank is made to be a high concentration of 2,000 to 50,000 mg/L, in particular, 5,000 to 20,000 mg/L, the biological treatment efficiency can be increased.

The ratio of the amount of organic matter to MLSS, specifically, an MLVSS (mixed liquor volatile suspended solids)/MLSS ratio is preferably in the range of about 0.1 to 0.8, in particular, 0.2 to 0.6. When the organic-matter concentration of organic-matter-containing water introduced into the biological treatment tank is excessively low (for example, the concentration of assimirable organic carbon (hereafter, AOC), which is a biodegradable organic matter, is less than about 100 ng/L), the growth rate of activated sludge in the biological treatment tank decreases and the MLVSS/MLSS ratio may become out of the range. In such a case, a small amount of organic matter may be added to the biological treatment tank or another organic-matter-containing water having a high organic-matter concentration may be added to the biological treatment tank.

A carrier may be suspended in the biological treatment tank. Examples of such a suspended carrier include sponge and gel. The BOD load in the biological treatment tank may be the same as that in the standard activated-sludge process and is preferably, for example, 0.5 to 5.0 kg-BOD/day, in particular, about 0.5 to 2.0 kg-BOD/day. Even when the load is lower than such a value, flocs having a sufficiently high strength are formed without dispersion of the sludge due to the iron salt and the treatment can be sufficiently performed.

According to the present invention, prior to the biological treatment of raw water with the biological treatment tank, the raw water is first supplied to the iron-salt-mixing tank 1; a pH adjusting agent is optionally added with pH-adjusting-agent addition means 1C operatively connected with a pH meter 1B such that the pH of the raw water is adjusted to be 4.5 to 6.5; an iron salt is added to the raw water under such a pH condition, and stirring and mixing are performed.

The iron salt is not particularly limited and examples thereof include ferric chloride, ferrous chloride, polyferric sulfate, and ferric sulfate. These examples may be used alone or in combination of two or more thereof. The iron salt is preferably added in the form of an aqueous solution. Examples of means for adding the aqueous solution of the iron salt to the mixing tank 1 include various chemical feed pumps.

The iron salt is preferably added in an amount such that the iron content (Fe content) in the activated-sludge MLSS in the biological treatment tank 2 becomes 10 to 45 wt %, in particular, 10 to 35 wt %. When the amount of the iron salt added is excessively low, the effect of the addition is not sufficiently provided. When the amount of the iron salt added is excessively high, the amount of the activated sludge is increased and the strength of flocs is decreased.

Although the amount of the iron salt added is preferably controlled on the basis of analysis of the Fe content of the activated-sludge MLSS, it may be simply controlled on the basis of the BOD of raw water. For example, the amount of the iron salt added in terms of Fe with respect to 1 mg/L of the BOD of raw water is preferably made about 0.03 to 0.3 mg/L. While the iron salt is added such that this range is satisfied, the amount of the iron salt added is preferably slightly controlled on the basis of analysis of the Fe content of the sludge MLSS.

When the pH in the iron-salt-mixing tank 1 in which the iron salt is added to decarbonated water of raw water is less than 4.5, very fine particles of iron hydroxide are generated and the sedimentation property of the sludge is degraded; when the pH is more than 6.5, carbon dioxide in the air dissolves again in the water to generate ferrous carbonate and flocculation of humic acid and the like is not sufficiently achieved. Accordingly, the pH in the iron-salt-mixing tank 1 is preferably 4.5 to 6.5, in particular, 4.5 to 5.5.

In the existing activated-sludge process, the addition of an iron salt to the biological treatment tank is generally performed for the purpose of, for example, suppressing bulking and removal of phosphorus. However, in this case, the iron salt is added in a very small amount for removing phosphorus or the iron salt is added in an amount such that bulking can be suppressed. In addition, the pH is not controlled; or, even when the pH is controlled, the pH is generally adjusted to be 6.5 or more for removal of phosphorus or nitrification.

As described below, according to the present invention, the pH in the biological treatment tank is preferably made to be 5 to 6.5, more preferably 5.5 to 6.0; while this condition is satisfied, an iron salt is added to raw water in the mixing tank 1, which is another tank provided, and the pH of the mixing tank 1 is preferably made to be 4.5 to 6.5.

As a result of such an operation, the SS of the biologically treated water always becomes 5 mg/L or less, generally 2 mg/L or less; and the transparency of the biologically treated water becomes 3 m or more. When the operation is applied to the membrane-separation activated-sludge process in which the biologically treated water is subjected to membrane separation, the membrane flux can be increased from the standard flux of 0.5 m/day to about 1 m/day.

In the iron-salt-mixing tank 1, raw water and an iron salt are preferably stirred and mixed for a retention time of about 3 to 20 minutes so that they are sufficiently mixed.

The water obtained by the addition and mixing of the iron salt in the iron-salt-mixing tank 1 is then supplied to the biological treatment tank 2 and biologically treated.

In the biological treatment tank 2, a pH adjusting agent is optionally added with pH-adjusting-agent addition means 2C operatively connected with a pH meter 2B; and the biological treatment is performed preferably at a pH of 5 to 6.5, more preferably 5.5 to 6.0, under aeration with a diffuser tube 2A.

The pH adjusting agent optionally added in the iron-salt-mixing tank 1 and the biological treatment tank 2 is an acid such as hydrochloric acid or an alkali. The alkali is preferably a soda alkali such as caustic soda rather than hydrated lime to suppress generation of scales.

When biologically treated water is subjected to solid-liquid separation with a separation membrane, the separation membrane may be an MF (microfiltration) membrane, a UF (ultrafiltration) membrane, an NF (nanofiltration) membrane, or the like. The membrane may have a form of a plate and frame membrane, a tubular membrane, a hollow fiber, or the like. Non-limiting examples of the material of the membrane include PVDF (polyvinylidene fluoride), PE (polyethylene), and PP (polypropylene). The separation membrane may be disposed so as to be submerged in the biological treatment tank 2 as illustrated in FIG. 1 or may be disposed as a pressure membrane-separation device that is separate from the biological treatment tank 2 as illustrated in FIG. 2. The submerged membrane is more preferable because flocs are less likely to be broken.

In the biological treatment tank illustrated in FIG. 1, the water mixture from the iron-salt-mixing tank 1 is introduced into the biological treatment tank 2 and mixed with activated sludge and biologically treated under aeration with the diffuser tube 2A disposed in a bottom portion of the biological treatment tank 2.

A pH adjusting agent such as an acid or an alkali is added with the pH-adjusting-agent addition means 2C to the biological treatment tank 2 such that the pH determined with the pH meter 2B falls within a predetermined range. The biologically treated water is made to permeate a separation membrane 3 and extracted as treated water. Although the permeated water is extracted with a pump 4 in FIG. 1, the permeated water may be extracted by gravity.

The excess sludge in the biological treatment tank 2 is extracted through an extraction tube 2D. A portion of the extracted sludge may be solubilized with ozone or the like and then returned to the biological treatment tank 2.

The separation membrane 3 is disposed so as to be submerged in the biological treatment tank 2 in FIG. 1. Alternatively, as illustrated in FIG. 2, the biologically treated water in the biological treatment tank 2 may be supplied to a pressure membrane-separation device 6 with a pump 5; the permeated water is extracted as treated water; and a portion of (or the entirety of) the concentrated water may be returned to the biological treatment tank 2.

Non-limiting examples of the type of the membrane used in the membrane-separation device 6 include an MF membrane and a UF membrane. Non-limiting examples of the form of the membrane module used in the membrane-separation device 6 include a hollow-fiber membrane, a plate and frame membrane, and a spiral wound membrane.

In the case of FIG. 2, a portion of the concentrated water from the membrane-separation device 6 may also be introduced into a sludge solubilization tank, solubilized with ozone or the like, and then returned to the biological treatment tank 2.

As described above, the submerged separation membrane 3 illustrated in FIG. 1 is preferably used because flocs are less likely to be broken, compared with the pressure membrane-separation device 6 in FIG. 2.

According to the present invention, in an organic-wastewater biological treatment method of subjecting biologically treated water to solid-liquid separation through direct membrane separation as illustrated in FIGS. 1 and 2, in particular, in an organic-wastewater biological treatment method of subjecting biologically treated water to membrane separation with a submerged membrane module submerged in a biological treatment tank, clogging of the membrane is suppressed to effectively suppress a decrease in the membrane flux and treated water of high quality can be obtained.

In the present invention, the solid-liquid separation of biologically treated water may also be performed with, other than a separation membrane, a sedimentation tank, a cyclone, or the like. When a sedimentation tank is used, the sedimentation property of sludge in the sedimentation tank and concentrated water can be improved; and the SS of separated water (treated water) can be decreased to increase the transparency of the treated water.

When any of the solid-liquid separation means is used, a portion of the solid content (separated sludge) having been separated from the liquid content may be optionally returned as return sludge to the biological treatment tank. The sludge is preferably extracted such that the sludge retention time in the biological treatment tank is about 2 to 50 days, in particular, about 5 to 20 days. When a submerged separation membrane is used, the sludge is preferably extracted such that such a sludge retention time is satisfied. The extracted sludge may be discharged as excess sludge or may be reduced in volume by volume reduction means such as an ozone reaction tank or a digester.

### EXAMPLES

Hereinafter, Example and Comparative examples will be described.

For convenience of explanation, Comparative examples will be first described.

### Comparative Example 1

Raw water was treated with the apparatus illustrated in FIG. 1; however, the iron-salt-mixing tank was not used and the raw water was directly introduced into the biological treatment tank. The volume of the biological treatment tank was 0.2 m³. Submerged membranes were submerged in the biological treatment tank. The submerged membranes were hollow-fiber MF membranes (manufactured by MITSUBISHI RAYON CO., LTD.) each having an area of 4 m² and a pore size of 0.1 μm.

Organic wastewater obtained by adding monopotassium phosphate to river water having a BOD concentration of 4.2 mg/L and an SS concentration of 3 mg/L so as to have a phosphorus concentration of 0.3 mg/L was fed to the biological treatment tank at a flow rate of 3 m³/day. Treated water (membrane-permeated water) was extracted through a treated-water pipe connected to the submerged membranes by reducing the pressure with a vacuum pump disposed at an intermediate position of the treated-water pipe.

In Comparative example 1, it became impossible to extract the treated water due to clogging of the membranes after the lapse of one day from the initiation of the experiment. At this time, the TOC concentration of the treated water was 1.2 mg/L and the activated-sludge mixed liquor in the tank had the following properties.

### Activated-Sludge Mixed Liquor in Biological Treatment Tank

Iron content; 4.7 wt % of MLSS (in terms of iron)

MLSS concentration; 500 mg/L

MLVSS concentration; 220 mg/L

pH; 7.1

### Comparative Example 2

The biological treatment tank from which the treated water was no longer able to be extracted in Comparative example 1 was emptied. Activated sludge was added to the biological treatment tank such that the MLSS concentration became 100 mg/L. A ferric chloride was added as an iron salt to this mixed liquor such that a proportion of 1,000 mg/L in terms of iron was satisfied. The pH was adjusted by addition of sodium hydroxide in conjunction with a pH meter in the biological treatment tank such that a pH of 5.8 was maintained. The raw water for treatment in Comparative example 1 was mixed with a 5.0 wt % aqueous solution of ferric chloride such that a proportion of 5 mg/L in terms of iron was satisfied, and supplied to the biological treatment tank at a flow rate of 1.2 m³/day. An increase in the differential pressure of the submerged membranes became small after the lapse of three days from the initiation of supply of the water.

At this time, the TOC concentration of the treated water was 145 ng/L and the activated-sludge mixed liquor in the biological treatment tank had the following properties.

### Activated-Sludge Mixed Liquor in Biological Treatment Tank

Iron content; 35 wt % of MLSS (in terms of iron)

MLSS concentration; 1870 mg/L

MLVSS concentration; 140 mg/L

pH; 5.8

However, while the operation was continued, the differential pressure of the submerged membranes increased and the submerged membranes needed to be chemically cleaned after the lapse of two weeks. The mixed liquor was taken out and the sedimentation property was checked. After the mixed liquor was left at rest for 30 minutes, the supernatant liquor was brown and turbid; and the SS was measured and found to be 22 mg/L.

### Example 1

The treatment was performed under the same conditions as in Comparative example 2 except that the raw water was introduced not into the biological treatment tank but into the iron-salt-mixing tank (volume: 10 L) provided upstream of the biological treatment tank; an aqueous solution of ferric chloride was added to the iron-salt-mixing tank, and the organic wastewater and the ferric chloride were stirred and mixed for five minutes and then supplied to the biological treatment tank. The pH in the iron-salt-mixing tank was 6.5.

As a result, substantially no increase in the differential pressure of the submerged separation membranes was observed. The operation was stably continued for two months. The increase in the differential pressure after the lapse of two months was 30 kPa.

The amount of iron added was then automatically adjusted such that the pH in the iron-salt-mixing tank was 5.0. As a result, no increase in the differential pressure of the submerged membranes was observed at all in the following two months.

At this time, the TOC concentration of the treated water was 120 ng/L and the activated-sludge mixed liquor in the biological treatment tank had the following properties.

### Activated-Sludge Mixed Liquor in Biological Treatment Tank

Iron content; 31 wt % of MLSS (in terms of iron)

MLSS concentration; 3,900 mg/L

MLVSS concentration; 1,570 mg/L

pH; 5.8

The submerged membranes were removed from the biological reaction tank. Instead of the submerged membranes, a circular sedimentation basin having a diameter of 30 cm and a height of 50 cm was disposed. The biologically treated solution from the biological treatment tank was introduced into the sedimentation basin so as to be subjected to solid-liquid separation and the separated water was extracted as treated water. In addition, a sludge return line was disposed and separated sludge was returned to the biological treatment tank. The sludge return percentage was 100%.

As a result, the SS of the treated water was always 5 mg/L or less and the treated water was clear during the two-month operation period.

While the present invention has been described in detail and with reference to specific embodiments thereof, it will be apparent to one skilled in the art that various modifications can be made without departing from the spirit and scope of the present invention.

The present application is based on Japanese Patent Application No. 2008-193623 filed in the Japan Patent Office on Jul. 28, 2008, the entire contents of which are incorporated herein by reference.

1. An organic-wastewater treatment method of adding an iron salt to organic wastewater and biologically treating the organic wastewater, the method comprising:
a mixing step of adding an iron salt to organic wastewater and conducting mixing; and
a biological treatment step of mixing a water mixture from the mixing step with activated sludge and biologically treating the water mixture.

2. The organic-wastewater treatment method according to claim 1, wherein the mixing step is performed at a pH of 4.5 to 6.5 and the biological treatment step is performed at a pH of 5 to 6.5.

3. The organic-wastewater treatment method according to claim 1, wherein, in the mixing step, the iron salt is added such that an iron content in the activated sludge in the biological treatment step is 10 to 45 wt %.

4. The organic-wastewater treatment method according to claim 1, wherein the iron salt is at least one selected from the group consisting of ferric chloride, ferrous chloride, polyferric sulfate, and ferric sulfate.

5. The organic-wastewater treatment method according to claim 1, further comprising a membrane-separation step of subjecting an activated-sludge mixed liquor from the biological treatment step to membrane separation.

6. The organic-wastewater treatment method according to claim 5, wherein a separation membrane for the membrane separation is a membrane selected from the group consisting of a microfiltration membrane, an ultrafiltration membrane, and a nanofiltration membrane.

7. An organic-wastewater treatment apparatus comprising:
a mixing tank configured to mix organic wastewater and an iron salt;
iron-salt addition means for adding the iron salt to the mixing tank; and
a biological treatment tank configured to mix a water mixture from the mixing tank with activated sludge and to biologically treat the water mixture.

8. The organic-wastewater treatment apparatus according to claim 7, wherein a pH in the mixing tank is 4.5 to 6.5 and a pH in the biological treatment tank is 5 to 6.5.

9. The organic-wastewater treatment apparatus according to claim 7, wherein the iron-salt addition means adds the iron salt to the mixing tank such that an iron content in the activated sludge in the biological treatment tank is 10 to 45 wt %.

10. The organic-wastewater treatment apparatus according to claim 7, further comprising membrane-separation means for subjecting an activated-sludge mixed liquor in the biological treatment tank to membrane separation.
